(19) United States
(12) Patent Application Publication
(10) Pub. No.: US 2009/0095401 A1
(43) Pub. Date: Apr. 16, 2009

(54) RURAL AND URBAN CAMOUFLAGED STRUCTURES

(75) Inventors: Ricky G. Tucker, Woodstock, GA (US); Kevin Stramara, Chantilly, VA (US); Alan Cornett, Andover, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 12/238,114

(22) Filed: Sep. 25, 2008

Related U.S. Application Data
(60) Provisional application No. 60/995,586, filed on Sep. 27, 2007.

(51) Int. Cl. B32B 5/18; B29C 65/54

(52) U.S. Cl. 156/61; 156/349

(57) ABSTRACT

A method for constructing a camouflaged structure or site by spraying a foam material on a camouflage material is provided. The foam material adheres to camouflage materials and cures quickly to form a camouflaged structure. The foam material is lightweight and portable. Also provided is a kit for constructing a camouflaged structure by the present method.

### CROSS REFERENCE TO RELATED APPLICATIONS

This application claims the benefit of U.S. Provisional Application No. 60/995,586, filed on Sep. 27, 2007, the contents of which are incorporated by reference herein.

### BACKGROUND

1. Field of Invention

The disclosure generally relates to a method and system for constructing a camouflaged structure. In particular, the disclosure pertains to a lightweight, portable polyurethane foam and/or polyisocyanurate foam used in combination with a camouflaged material or structure.

2. Discussion of Related Art

Ease and time required to construct camouflaged structures or sites in a wide variety of existing field conditions and environments is becoming a larger issue due to remote locations of some sites and the inability to transport materials or the high cost of such materials, as well as the delay caused by long construction times required to assemble such structures. Current construction methods and processes are not always consistent with the existing field or environmental conditions. In addition, such conventional construction techniques and materials are time consuming, labor intensive, costly, material intensive and require advanced planning.

Furthermore, current technologies are factory manufactured or, if field constructed, very time and labor intensive. As an example, some conventional technologies may involve pre-manufacturing of camouflaged fabrics, screens, tarps, structures and/or materials. Other examples include gathering of natural elements found in the environment and assembling them into a camouflaged configuration to match the natural surroundings of the site. In addition, it can take hours, days or even weeks to construct camouflaged structures or sites.

The present disclosure provides numerous advantages over these conventional camouflaged systems, such as being near identical to the existing environment, lightweight, portable, quick to construct, and labor saving.

The present disclosure also provides many additional advantages, which shall become apparent as described below.

### SUMMARY OF THE INVENTION

A system and method for constructing a camouflaged structure or site by spraying polyurethane and/or polyisocyanurate foam into a desired shape or configuration over the top of a camouflage material. The foam has sufficient adhesive properties to attach to the camouflage material, such as grass, leaves, rocks, sand, soil, wood chips, bark, building materials, garbage, debris, etc.

A preferred foam material is polyurethane and polyisocyanurate closed-cell foams prepared with a blowing agent comprising a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof.

The present disclosure includes a unique foam-based camouflaged structure or site, wherein the preferred foam is formed by a method of preparing polyurethane and/or polyisocyanurate foam compositions comprising the step of reacting and foaming a mixture of ingredients which react to form a polyurethane and/or polyisocyanurate foam in the presence of: a blowing agent selected from the group consisting of water, carbon dioxide, methyl formate, a hydrocarbon, a hydrofluorocarbon, and combinations thereof; and an effective amount of a blowing agent additive (“additive”) selected from the group consisting of α-methyl styrene, isobutanol, isopropanol, and mixtures thereof. The additive can be present in the amount of from about 0.02 to about 10 weight percent, based on the amount of blowing agent.

Another embodiment includes a closed cell foam prepared from a polymer foam formulation comprising: a blowing agent comprising a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof; and an additive selected from the group consisting of: α-methyl styrene, isobutanol, isopropanol, and mixtures thereof.

Optionally, the closed cell foam containing a cell gas comprises a blowing agent as defined above.

Further objects, features and advantages of the present disclosure will be understood by reference to the following drawings and detailed description.

### BRIEF DESCRIPTION OF THE DRAWINGS

FIG. 1 depicts a foam spraying system for use in accordance with the present disclosure;

FIG. 2 is a top planar view of the foam material used in accordance with the present disclosure; and

FIG. 3 is a front right-side perspective view of a camouflage material affixed to the foam material in accordance with the present disclosure.

### DETAILED DESCRIPTION OF THE INVENTION

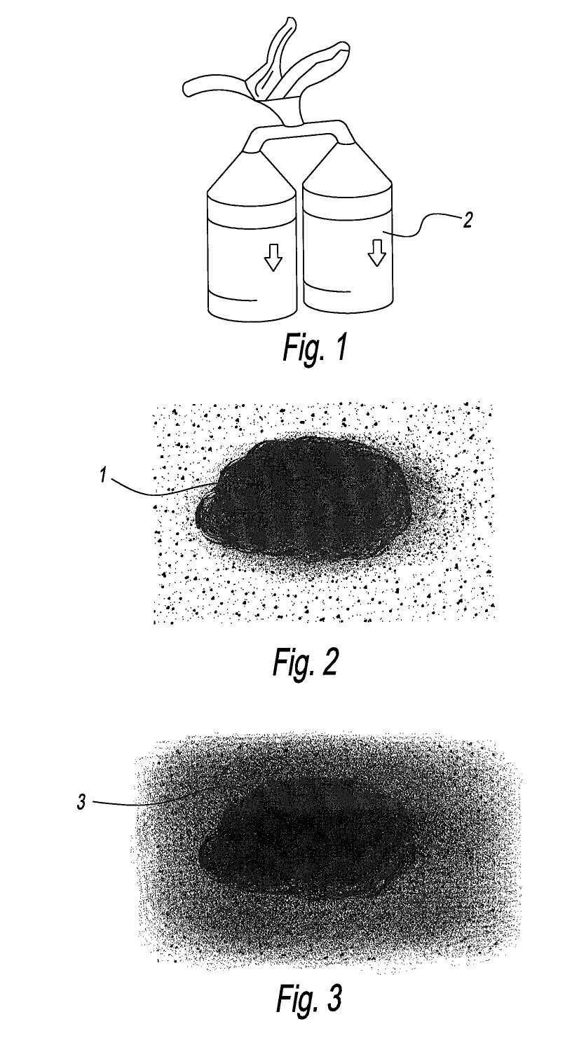

The present disclosure can best be described by referring to the figures. FIG. 1 illustrates a foam material system having one or more containers 2 and a dispensing apparatus. The one or more containers 2 contain one or more compositions that are dispensed through the dispensing apparatus and form a foam material 1. FIGS. 2 and 3 demonstrate how foam material 1 adheres to camouflage material 3, such as dirt, as shown in FIG. 3, to provide a visible barrier which blends into the surrounding environment.

It is critical to the present invention that foam material 1 provide quick-setting, strength and durability. One preferred foam is recited in U.S. Pat. No. 6,545,063, “Hydrofluorocarbon blown foam and method for preparation thereof,” which is incorporated herein in its entirety.

The preferred foam material is polyurethane and/or polyisocyanurate foam. The foam material can be open-celled or closed-cell foam, and is preferably closed-cell foam. More particularly, the foam material can include the addition of α-methyl styrene, isobutanol and/or isopropanol to reduce vapor pressure, improve k-factor, enhance the solubility of the blowing agent in the premix and/or improve the processing characteristics of polyurethane and polyisocyanurate foams prepared with a blowing agent selected from the group consisting of water, carbon dioxide, methyl formate, a hydrocarbon, a hydrofluorocarbon selected from the group consisting of HCFC, HFC, low GWP HFC, 1,1,1,3,3-pentafluoropropane (HFC-245fa), 1,1,1,2-tetrafluoroethane (HFC-134a), 1,1,2,2-tetrafluoroethane (HFC-134), 1,1,1,3,3-pentafluorobutane (HFC-365mfc), 1,1,1,2,3,3,3-heptafluoropropane (HFC-227ea), and mixtures thereof.

The preferred foam material of the present disclosure includes the addition of one or more of α-methyl styrene, isobutanol and/or isopropanol to the B-side of a polyurethane and/or polyisocyanurate foam formulation comprising a blowing agent comprising a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof, resulting in reduced vapor pressure, improved k-factor, enhanced solubility of the blowing agent and/or improved processing characteristics of the foams. The addition of α-methyl styrene to the foam formulation results in improved thermal conductivity (k-factor) and thermal aging characteristics. With respect to thermal conductivity, the term “improved” refers to a decrease in the k-factor of the foam.

The polyurethane and/or polyisocyanurate foam compositions can be prepared by: reacting and foaming a mixture of ingredients which react to form polyurethane and/or polyisocyanurate foams in the presence of a blowing agent comprising a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof, and an effective amount of an additive selected from the group consisting of α-methyl styrene, isobutanol, isopropanol and mixtures thereof. The additive is present in an amount from about 0.02 to about 10 weight percent, based on the amount of blowing agent. In another embodiment, the method of preparing polyurethane and polyisocyanurate foam compositions comprises the step of reacting and foaming a mixture of ingredients which react to form polyurethane foam and/or polyisocyanurate foam in the presence of a blowing agent comprising 1,1,1,3,3-pentafluoropropane, and an additive comprising α-methyl styrene, preferably from about 0.02 to about 5 weight percent α-methyl styrene, based on the amount of blowing agent.

A preferred closed cell foam is prepared from a polymer foam formulation containing as a blowing agent a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof, and an effective amount of an additive selected from the group consisting of α-methyl styrene, isobutanol, isopropanol and mixtures thereof, preferably from about 0.02 to about 10 weight percent of the additive, based on the amount of blowing agent. In one embodiment, the closed cell foam is prepared from a polymer foam formulation containing a blowing agent 1,1,1,3,3-pentafluoropropane, and an additive α-methyl styrene.

In another embodiment, the closed cell foam contains a cell gas comprising a blowing agent comprising a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof, and an additive selected from the group consisting of: α-methyl styrene, isobutanol, isopropanol and mixtures thereof, preferably from about 0.02 to about 10 weight percent of the additive, based on the amount of blowing agent. In a preferred embodiment, the closed cell foam contains a cell gas comprising 1,1,1,3,3-pentafluoropropane as a blowing agent and α-methyl styrene as an additive, preferably from about 0.02 to about 5 weight percent α-methyl styrene, based on the amount of blowing agent.

The preferred blowing agent composition comprises a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and mixtures thereof, and an additive selected from the group consisting of: α-methyl styrene, isobutanol, isopropanol, and mixtures thereof, preferably from about 0.02 to about 10 weight percent of the additive, based on the amount of blowing agent. In one embodiment, the blowing agent composition is 1,1,1,3,3-pentafluoropropane and α-methyl styrene, preferably from about 0.02 to about 5 weight percent α-methyl styrene, based on the amount of blowing agent.

As used herein, an effective amount of additive means an amount, based on the amount of blowing agent, which reduces the vapor pressure of a foam formulation B-side to below the vapor pressure of the corresponding foam prepared in the absence of additive. Generally, an effective amount is from about 0.02 to about 10 weight percent, based on the amount of blowing agent. The α-methyl styrene is preferably added in an amount of from about 0.5 to about 2 weight percent, based on the amount of blowing agent.

As used herein, blowing agent composition refers to HFC-245fa or HFC-134a singly or in combination with other non-ozone depleting blowing agents, such as, for example, other hydrofluorocarbons, e.g., difluoromethane (HFC-32), difluoroethane (HFC-152), trifluoroethane (HFC-143), tetrafluoroethane (HFC-134), pentafluoropropane (HFC-245), pentafluorobutane (HFC-365), hexafluoropropane (HFC-236), and heptafluoropropane (HFC-227); C₄-C₇ hydrocarbons, including but not limited to butane, isobutane, n-pentane, isopentane, cyclopentane, hexane and isohexane; inert gases, e.g., air, nitrogen, carbon dioxide; and water, in an amount of from about 0.5 to about 2 parts per 100 parts of polyol. Where isomerism is possible for the hydrofluorocarbons mentioned above, the respective isomers may be used either singly or in the form of a mixture.

HFC-245fa is a known material and can be prepared by methods known in the art such as those disclosed in WO 94/14736, WO 94/29251, WO 94/29252 and U.S. Pat. No. 5,574,192. Difluoroethane, trifluoroethane, tetrafluoroethane, pentafluoropropane, pentafluorobutane, hexafluoropropane and heptafluoropropane are available for purchase from Honeywell, Inc., Morristown, N.J., USA. The α-methyl styrene, isobutanol and isopropanol components of the disclosure are also commercially available.

With respect to the preparation of rigid or flexible polyurethane or polyisocyanurate foams using a blowing agent comprising 1,1,1,3,3-pentafluoropropane or 1,1,1,2-tetrafluoroethane, any of the methods well known in the art can be employed. See Saunders and Frisch, Volumes I and II Polyurethanes Chemistry and Technology (1962). In general, polyurethane or polyisocyanurate foams are prepared by combining under suitable conditions an isocyanate (or isocyanurate), a polyol or mixture of polyols, a blowing agent or mixture of blowing agents, and other materials such as catalysts, surfactants, and optionally, flame retardants, colorants, or other additives.

It is convenient in many applications to provide the components for polyurethane or polyisocyanurate foams in pre-blended foam formulations. Most typically, the foam formulation is pre-blended into two components. The isocyanate or polyisocyanate composition comprises the first component, commonly referred to as the “A” component or “A-side.” The polyol or polyol mixture, surfactant, catalysts, blowing agents, flame retardant, water and other isocyanate reactive components comprise the second component, commonly referred to as the “B” component or “B-side.” While the surfactant and fluorocarbon blowing agent are usually placed on the polyol side, they may be placed on either side, or partly on one side and partly on the other side. Accordingly, polyurethane or polyisocyanurate foams are readily prepared by bringing together the A and B side components either by hand mix, for small preparations, or preferably machine mix techniques to form blocks, slabs, laminates, pour-in-place panels and other items, spray applied foams, froths, and the like. Optionally, other ingredients such as fire retardants, colorants, auxiliary blowing agents, water and even other polyols can be added as a third stream to the mix head or reaction site. Most conveniently, however, they are all incorporated into one B component.

The α-methyl styrene, isobutanol and isopropanol additives of the present invention may be added to B-side of the foam formulation, or to the blowing agent per se, by any manner well known in the art.

Any organic polyisocyanate can be employed in polyurethane or polyisocyanurate foam synthesis inclusive of aliphatic and aromatic polyisocyanates. Preferred as a class are the aromatic polyisocyanates. Preferred polyisocyanates for rigid polyurethane or polyisocyanurate foam synthesis are the polymethylene polyphenyl isocyanates, particularly the mixtures containing from about 30 to about 85 percent by weight of methylenebis(phenylisocyanate) with the remainder of the mixture comprising the polymethylene polyphenyl polyisocyanates of functionality higher than 2. Preferred polyisocyanates for flexible polyurethane foam synthesis are toluene diisocyanates including, without limitation, 2,4-toluene diisocyanate, 2,6-toluene diisocyanate, and mixtures thereof.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Typical polyols used in the manufacture of flexible polyurethane foams include, but are not limited to, those based on glycerol, ethylene glycol, trimethylolpropane, ethylene diamine, pentaerythritol, and the like condensed with ethylene oxide, propylene oxide, butylene oxide, and the like. These are generally referred to as “polyether polyols.” Another example is the graft copolymer polyols which include, but are not limited to, conventional polyether polyols with vinyl polymer grafted the polyether polyol chain. Yet another example is polyurea modified polyols which consist of conventional polyether polyols with polyurea particles dispersed in the polyol.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose based polyols, and used in polyurethane foam applications.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl) ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts are used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic acid salts, and mixtures thereof. Preferred species within the classes are potassium acetate, potassium octoate, and N-(2-hydroxy-5-nonylphenol) methyl-N-methylglycinate.

Also included in the mixture are blowing agents or blowing agent blends. Generally speaking, the amount of blowing agent present in the blended mixture is dictated by the desired foam densities of the final polyurethane or polyisocyanurate foams products. The polyurethane foams produced can vary in density, for example, from about 0.5 pound per cubic foot to about 40 pounds per cubic foot, preferably from about 1 to about 20 pounds per cubic foot, and most preferably from about 1 to about 6 pounds per cubic foot. The density obtained is a function of how much of the blowing agent, or blowing agent mixture, is present in the A and/or B components, or that is added at the time the foam is prepared. The proportions in parts by weight of the total blowing agent or blowing agent blend can fall within the range of from 1 to about 60 parts of blowing agent per 100 parts of polyol. Preferably from about 10 to about 35 parts by weight of blowing agent per 100 parts by weight of polyol are used.

Dispersing agents, cell stabilizers, and surfactants may be incorporated into the blowing agent mixture. Surfactants, better known as silicone oils, are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458.

Other optional additives for the blowing agent mixture may include flame retardants such as tris(2-chloroethyl)phosphate, tris(2-chloropropyl) phosphate, tris(2,3-dibromopropyl)phosphate, tris(1,3-dichloropropyl)phosphate, diammonium phosphate, various halogenated aromatic compounds, antimony oxide, aluminum trihydrate, polyvinyl chloride, and the like.

The foam kit includes a polyurethane foam system with a disposable spray nozzle or dispensing apparatus or non-disposable dispensing apparatus. In addition, the foam kit forms a camouflaged membrane, quickly adheres to natural surroundings, forms in about 2 to 3 minutes (i.e., is quick setting), reduces thermal signature and requires minimal amount of training for users.

The combination of the polyurethane and/or polyisocyanurate foam plastic and existing camouflage materials, e.g., materials that can be readily found in the environment of the site, provides unique advantages over conventional camouflaged structures. For example, two 16 oz. canisters are able to create approximately 12 board feet of camouflaged membrane for concealment purposes according to the method and system of the present disclosure. The camouflaged membrane can be field manufactured in approximately 2 to 3 minutes for rapid deployment. In addition, this structure has the advantage of being usable in small and large scale applications with little training and expertise.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for constructing a camouflaged structure comprising:
adding a foam material to a camouflage material,
wherein said foam material adheres to said camouflage material to form the camouflaged structure.

2. The method according to claim 1, wherein said adding of said foam material comprises a desired shape and/or configuration for concealment of said camouflaged structure.

3. The method according to claim 1, wherein said foam material cures quickly to form the camouflaged structure in about 2 to 3 minutes.

4. The method according to claim 1, wherein the camouflaged structure has a reduced thermal signature.

5. The method according to claim 1, wherein the camouflaged structure is concealed from view by blending with the surrounding environment.

6. The method according to claim 1, wherein said camouflage material comprises a material from the surrounding environment that is selected from the group consisting of: grass, leaves, rocks, sand, soil, wood chips, bark, building materials, garbage, debris, and any combinations thereof.

7. The method according to claim 1, where said foam material is lightweight.

8. The method according to claim 1, wherein said foam material comprises a closed-cell foam.

9. The method according to claim 1, wherein said foam material is selected from the group consisting of: polyurethane foam, polyisocyanurate foam, and combinations thereof.

10. The method according to claim 9, wherein said foam material further comprises:
a blowing agent selected from the group consisting of: water, carbon dioxide, methyl formate, hydrocarbon, hydrochlorofluorocarbon (HCFC), hydrofluorocarbon (HFC), low Global Wanning Potential hydrofluorocarbon (low GWP HFC), and any combinations thereof; and
a blowing agent additive selected from the group consisting of: α-methyl styrene, isobutanol, isopropanol, and any combinations thereof.

11. The method according to claim 10, wherein said hydrofluorocarbon is selected from the group consisting of: 1,1,1,3,3-pentafluoropropane (HFC-245fa), 1,1,1,2-tetrafluoroethane (HFC-134a), 1,1,2,2-tetrafluoroethane (HFC-134), 1,1,1,3,3-pentafluorobutane (HFC-365mfc), 1,1,1,2,3,3,3-heptafluoropropane (HFC-227ea), and any combinations thereof.

12. The method according to claim 10, wherein said blowing agent additive is present in an amount of from about 0.02 to about 10 weight percent, based on a total amount of said blowing agent.

13. The method according to claim 10, wherein said blowing agent comprises 1,1,1,3,3-pentafluoropropane (HFC-245fa), and said blowing agent additive comprises α-methyl styrene; and
wherein said α-methyl styrene is present in an amount of from about 0.02 to about 10 weight percent based on a total amount of said 1,1,1,3,3-pentafluoropropane (HFC-245fa).

14. The method according to claim 10, wherein said polyurethane foam and/or polyisocyanurate foam comprises a pre-blended foam formulation, wherein said pre-blended foam formulation comprises:
a first component that is an “A-side” component; and
a second component that is a “B-side” component,
wherein said blowing agent is incorporated in said first component (“A-side”) and/or said second component (“B-side”), and
wherein said polyurethane foam and/or polyisocyanurate foam are prepared by mixing said first component (“A-side”) and said second component (“B-side”), and added to said camouflage material.

15. A kit for constructing a camouflaged structure, comprising:
a foam material system comprising one or more containers and a dispensing apparatus,
wherein said one or more containers contain one or more compositions that are dispensed through said dispensing apparatus and form a foam material.

16. The kit according to claim 15, wherein said foam material is selected from the group consisting of polyurethane foam, polyisocyanurate foam, and combinations thereof.

17. The kit according to claim 15, wherein the dispensing apparatus is a spray nozzle.

18. The kit according to claim 15, further comprising a camouflage material.
